(19) United States
(12) Patent Application Publication
(10) Pub. No.: US 2018/0084204 A1
(43) Pub. Date: Mar. 22, 2018

(54) SYSTEM, COMPUTER PROGRAM PRODUCT, AND METHOD FOR SUPERIMPOSING IMAGES CAPTURED IN A PHOTO BOOTH ONTO A SELECTED BACKGROUND

(71) Applicant: JAKKS Pacific, Inc., Santa Monica, CA (US)

(72) Inventors: Stephen Berman, Malibu, CA (US); Dominic Laurienzo, Rancho Palos Verdes, CA (US); Lizabeth Hogan, Los Angeles, CA (US)

(21) Appl. No.: 15/826,189

(22) Filed: Nov. 29, 2017

Related U.S. Application Data
(63) Continuation-in-part of application No. 14/751,003, filed on Jun. 25, 2015.
(60) Provisional application No. 62/017,670, filed on Jun. 26, 2014.

(51) Int. Cl. H04N 5/272; H04N 7/18; F16M 13/02

(52) U.S. Cl. CPC H04N 5/272; E04H 1/12; F16M 13/022; H04N 7/185

(57) ABSTRACT

Described is a system for superimposing images captured in a photo booth onto a selected background that can he used for panics and other events and that includes everything needed to instantaneously provide blue or green screen effects to event participants. The system includes one or more processors and a memory. The memory is a non-transitory computer-readable medium having executable instructions encoded thereon, such that upon execution of the instructions, the one or more processors cause a tablet computer to obtain an image of a participant in front of a chroma-key panel and superimpose the image over a background that is stored in the tablet computer.

### CROSS-REFERENCE TO RELATED APPLICATIONS

This is a Continuation-in-Part application of Ser. No. 14/751,003, tiled on Jun. 25, 2015, which is a non-provisional application of U.S. Provisional Application No. 62/017,670, filed on Jun. 26, 2014, the entirety of which are incorporated herein by reference.

### BACKGROUND OF THE INVENTION

### (1) Field of Invention

The present invention relates to a chroma key system and, more particularly, to a computer system, computer program product, and computer implemented method for digitally superimposing images captured in a photo booth onto a selected background.

### (2) Description of Related Art

Chrome key tools have long been known in the art. Chroma keying is a special effects technique for compositing (layering) two images or video streams together. Blue screens or green screens are often used as background screens in which a participant stands or acts. The participant is then selectively overlayed onto a different background, which provides the effect that the participant is actually in that background. For example, a participant running in front of a green screen can then be superimposed over a background with dinosaurs. The resulting effect is that the participant appears in a composited video running from dinosaurs. While chroma keying has long been used in the special effects industry, little advances have been made in the commercial or home use market.

Thus, a continuing need exists a kit that allows a user to easily implement chroma key technology for home use or events.

### SUMMARY OF INVENTION

This disclosure provides a system for superimposing images captured in a photo booth onto a selected background. The system includes one or more processors and a memory. The memory is a non-transitory computer-readable medium having executable instructions encoded thereon, such that upon execution of the instructions, the one or more processors perform an operation of causing a tablet computer to obtain an image of a participant in front of a chroma-key panel and superimpose the image over a background that is stored in the tablet computer.

The present invention is also directed to a photo booth kit that can he provided with or without the system and that can be used for parties and other events and that includes everything needed to instantaneously provide chroma key effects (e.g., blue or green screen) to event participants, such as at a birthday party, wedding, etc.

The kit includes a frame having a tablet mount adapted to hold a tablet computer. A cover is included that is formed to cover the frame and, together with the frame, forms a photo booth. At least one panel:in the cover includes a chroma-keyed color. Party supplies and props are included. The party supplies and props are formed to depict a coordinated theme (such as a movie theme). Finally, the kit includes instructions to download a photo booth software application. The photo booth software application is operable to cause the tablet computer to obtain photos of a user in front of the panel and superimpose the user over a background that is stored in the tablet computer and rendered by the photo booth software application.

In various aspects, the present invention is also directed to a system for superimposing images captured in a photo booth onto a selected background. The system (e.g., tablet computer), for example, includes one or more processors and a memory, the memory being a non-transitory computer-readable medium having executable instructions encoded thereon, such that upon execution of the instructions, the one or more processors perform an operation of causing a tablet computer to obtain an image of a participant in front of a chroma-key panel and superimpose the image over a background that is stored in the tablet computer.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is a block diagram depicting the components of a system according to various embodiments of the present invention;

FIG. 1B is an illustration of a computer program product embodying an aspect of the present invention;

FIG. 1C is an illustration of a frame structure according to an embodiment;

FIG. 2A is a perspective-view illustration of a tablet mount according to an embodiment;

FIG. 2B is a top-view illustration of the tablet mount;

FIG. 2C is a side-view illustration of the tablet mount;

FIG. 3 is an illustration of the tablet mount;

FIG. 4 is an illustration of a cover according to an embodiment, depicting the cover as positioned around the frame structure; and

FIG. 5 is an illustration depicting various items that can be supplied with the photo both kit according to an embodiment.

### DETAILED DESCRIPTION

The present invention relates to a chroma key system and, more particularly, to a computer system, computer program product, and method for superimposing images captured in a photo booth onto a selected background that can be used for parties and other events and that includes everything needed to instantaneously provide blue or green screen effects to event participants. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction Instead, they are used to reflect relative locations and/or directions between various portions of an object.

Before describing the invention in detail, first a description of the various principal aspects of the present invention is provided. Subsequently, specific details of various embodiment of the present invention are provided to give an understanding of the specific aspects.

(1) Principal Aspects

Various embodiments of the invention include three “principal” aspects. The first is a system for superimposing images captured in a photo booth onto a selected background. The system is typically in the form of a computer system operating software or in the form of a “hard-coded” instruction set and may include the relevant frame system, components, and props for building the photo booth. This system (e.g., tablet computer, etc.) may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

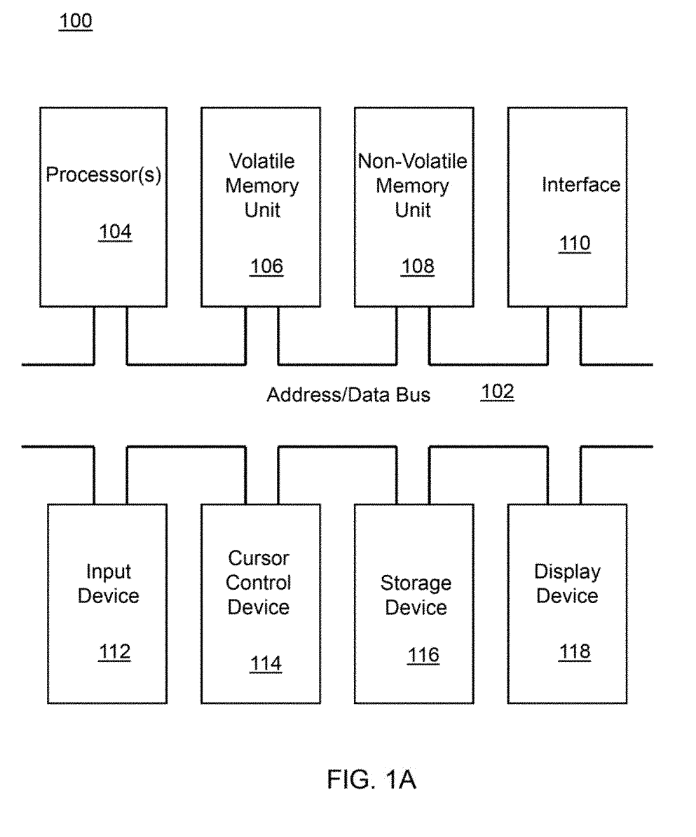

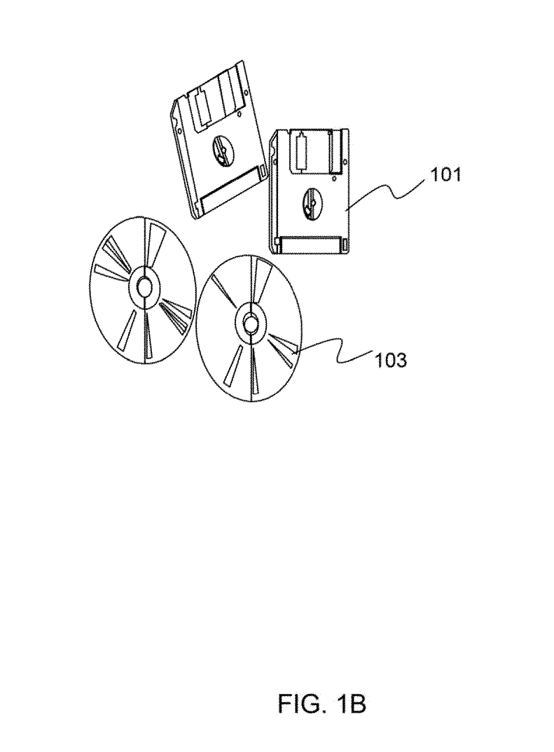

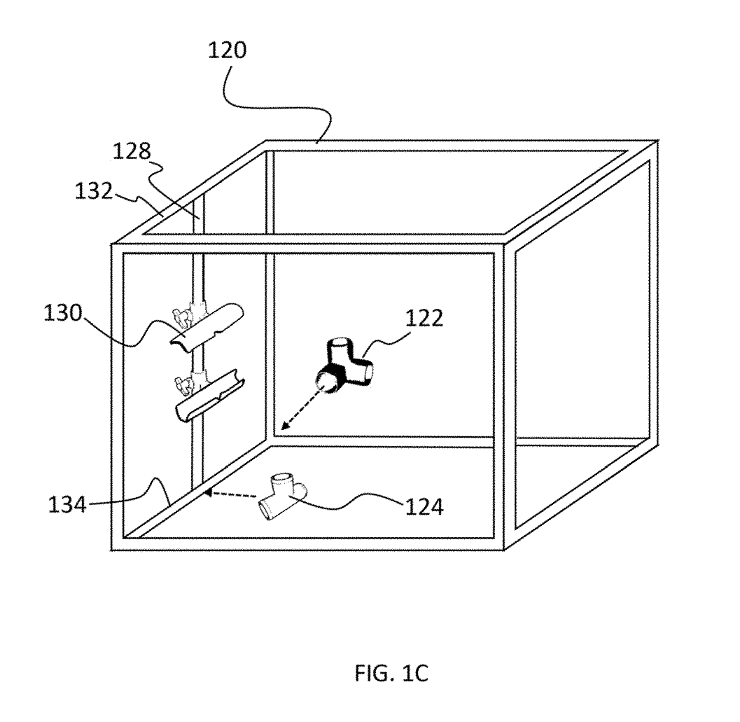

A block diagram depicting an example of a system (computer system 100) of the present invention is provided in. FIG. 1A. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and, exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system. 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

An illustrative diagram of a computer program product (i.e., storage device) embodying the present invention is depicted in FIG. 1B. The computer program product is depicted as floppy disk 101 or an optical disk 103 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Specific Details

The present invention is directed to a system, computer program product, and method for superimposing images captured in a photo booth onto a selected background that can be used for parties and other events and that includes everything needed to instantaneously provide blue or green screen effects to event participants. As shown in FIGS. 1A and 1B, the system includes all of the necessary software i.e., photo booth software) and/or hardware (including cameras, processors, photo booth, etc.) to implement the chroma key functions as described herein. In various embodiments, the present invention is also directed to a photo booth kit that can be used for parties and other events to provide chroma key effects (e.g., blue or green screen) to event participants, such as at a birthday party, wedding, etc.

The photo booth kit includes any number of items to allow for chroma key effects. For example, the kit can include the software (e.g., downloadable or downloaded software or a computer readable medium) as needed to allow for chroma key effects and can also be formed to include a big, rectangular cover (or any other desired shape) that is wrapped around a frame or structure, thereby forming the photo booth. As a non-limiting example as illustrated in FIG. 1C, the frame structure 120 is formed to provide a frame for a covering (e.g., cover or tent). The frame structure 120 is formed of any suitable material that provides a stable frame, a non-limiting example of which includes plastic tubing (or any other tubing or structure) that is snapped together to form a rectangular tent shape (or any other desired shape). Thus, in one embodiment, the frame structure 120 is formed of tubular pipes that can be connected with each other using appropriate fittings, such as 3-way corner connectors 122 and T-shaped connectors 124 as may be required. As a non-limiting example, such tubular connections are commonly used in the art and are similar to the fittings that one might find in sprinkler PVC piping system

To provide the chroma key effects, a photo booth software application can be included. The software application can be downloaded onto the user's smart phone or tablet computer through the internet or through any other suitable means. To provide the user the photo booth software application, the product packaging or instructions included with the photo booth kit include the relevant directions to direct the user to the appropriate site to download the photo booth software application. As a non-limiting example, the photo booth software application can be an iPad app that is available via iTunes, or any other suitable tablet and download medium. The photo booth software application includes all of the requisite software to provide the chromo key effects, such that when the user takes the photo and is standing in front of a green screen (or blue screen), the user's image is superimposed (layered) over the selected background. As understood by those skilled in the art, software applications are programs that can be loaded into a user's computing device to provide a variety of functions or features. As applied to the present invention, the photo booth software application can be loaded into a mobile device, such as a tablet computer or mobile phone. The software application uses the camera feature of the mobile device to take a picture or video of participants in the photo booth. Using commonly understood chromo key technology, the photo booth software application layers the image (of the participants) taken using the mobile device's camera over a background as selected by the participants (or a predetermined background). The composited image is then displayed to the participants and can be emailed or otherwise provided to the participant's via a desired medium, such as posted to a social media account or printed via a printer.

Chromo key technology is commonly understood by those skilled in the art. Thus, the photo booth software application is, in one embodiment, a computer program product. As noted above, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium. The “instructions” as applicable to the photo booth software application can be downloaded via the internee and include the necessary commands to cause the mobile device to take an image of participants in front of a chroma key screen (e.g., blue or green screen) and composite the images of the participants over the selected background. The photo booth software application includes a plurality of backgrounds from which >a user can select from and also allows a user to selectively take a photo, via timer or instantaneous screen activated button.

The frame 120 also includes any suitable mechanism or device to hold the mobile device at the appropriate location to take images of the participants. As a non-limiting example, the frame 120 includes a tablet support 128 with one or more tablet mounts 130. The tablet support 128 is connected, for example, with and between a top portion 132 and bottom portion 134 of the frame 120. For example, the tablet support 128 is a tubular frame member that is connected with the top and bottom portions 132 and 134 of the frame using Ti-shaped connectors 124. The tablet mounts 130 are adjustable along the length of the tablet support 128 to allow a user to selectively position the location of the tablet mounts 130 and, thereby, selectively position the camera direction and elevation of the mobile device.

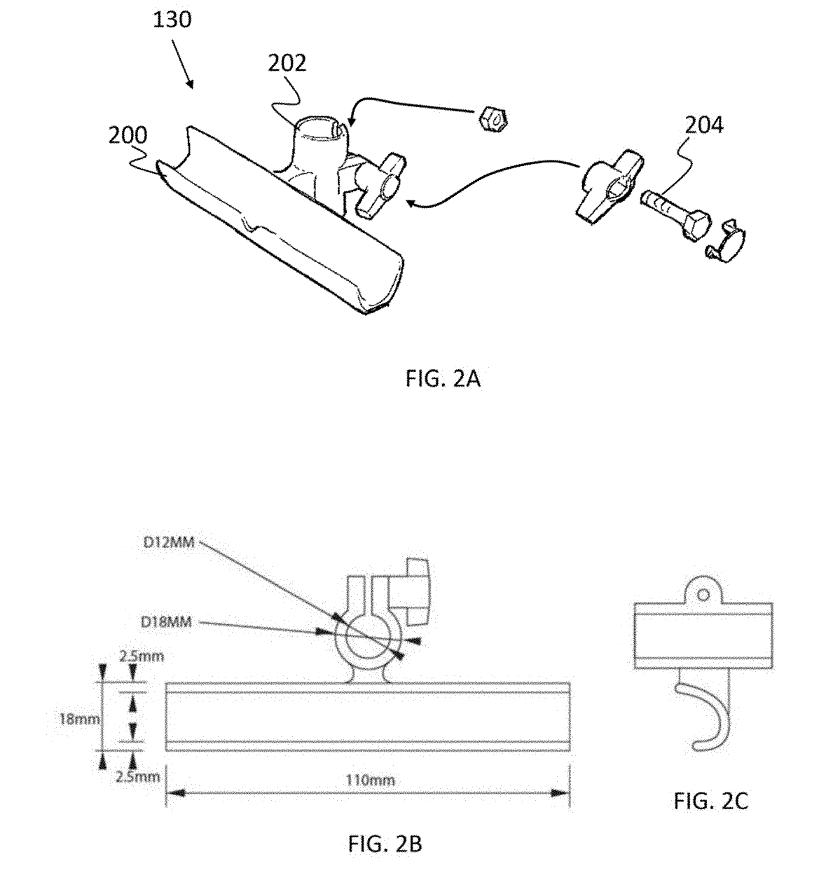

The tablet mounts 130 are any suitable mechanism or device that allow a user to selectively affix a mobile device (e.g., tablet computer) with the frame 120. As a non-limiting example and as shown in FIG. 2A, the tablet mount 130 includes a grip portion 200 and a connector sleeve 202. A tightening mechanism 204 is also included. Thus, while the connector sleeve 202 can be connected with the tablet support by passing the connector support through the connector sleeve 202, it should be understood that the connector sleeve 202 is provided as a non-limiting example of a suitable connection mechanism as any suitable connection mechanism can be employed. In one aspect, the tightening mechanism 204 is used to selectively set and fix the tablet mount 130 at the desired height along the tablet support. For further understanding, FIGS. 2B and 2C are a top and side-view, respectively, of the tablet mount 130. It should be understood that the specific dimensions as illustrated in FIG. 2B are provided as one non-limiting example of suitable dimensions; however, the invention is not intended to be limited thereto.

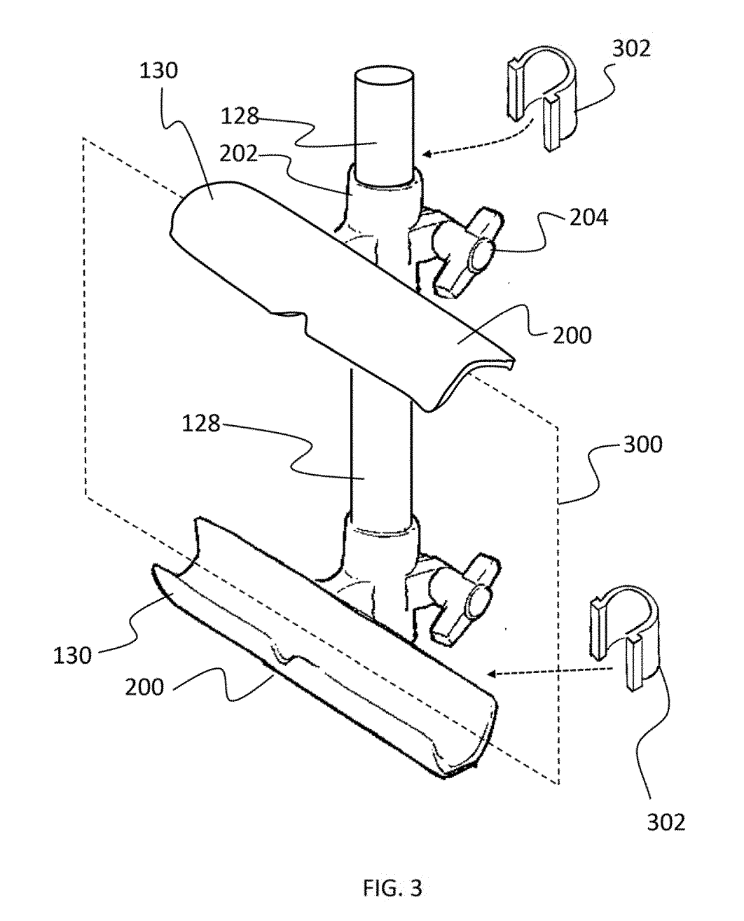

For further understanding, FIG. 3 depicts two tablet mounts 130 as affixed with a tablet support 128. As noted above, each tablet mount 130 includes a grip portion 200 and a connector sleeve 202. The grip portions 200 provide recessed surfaces that can be positioned around the top and bottom portions of a mobile device 300 to effectively hold and sandwich the mobile device 300 between the tablet mounts 130. Once set at the desired location using the tightening mechanism 204, a secondary lock can be employed to further fix the tablet mounts 130. As a non-limiting example, the secondary lock includes a pair of clips 302 that can be positioned around the tablet support 128 to further prevent the tablet mounts 130 from sliding along the tablet support 128. With the mobile device 300 secured against the tablet mounts 130, the user can selectively use the photo booth software application as loaded onto the mobile device 300.

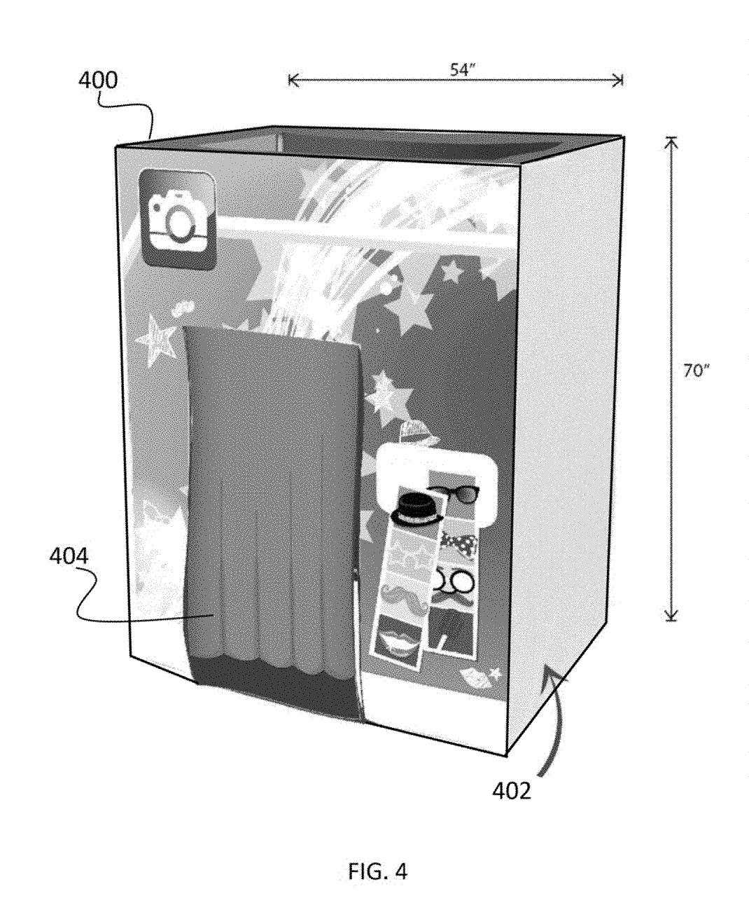

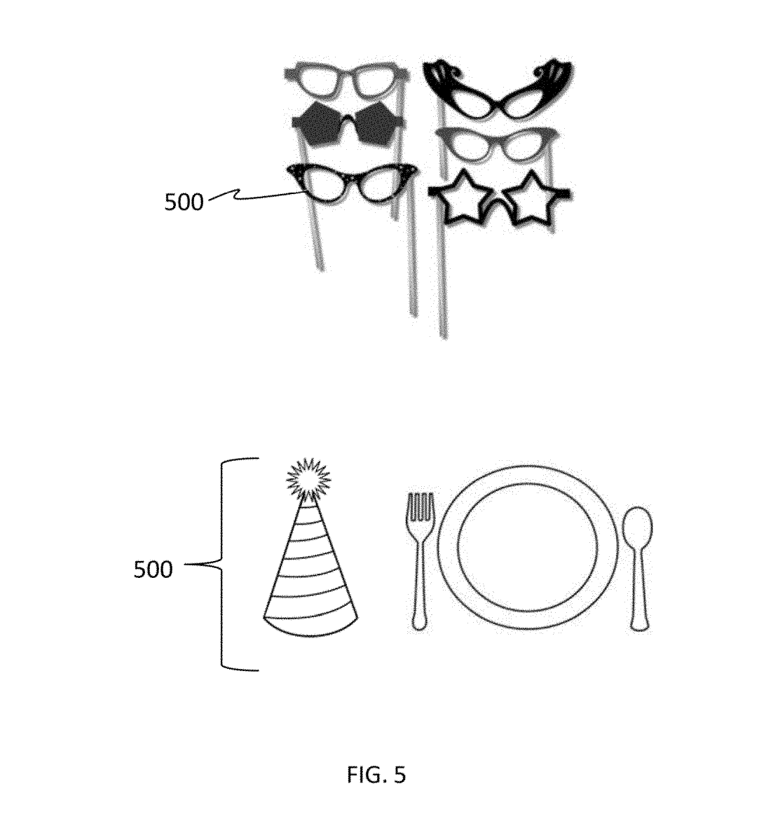

To obtain the chroma key effects as provided for by the photo booth software application, the participant needs to be positioned in front of a chroma key screen (e.g., blue screen or green screen). Thus, the photo booth kit also includes a chroma key screen. For example and as illustrated in FIG. 4, the photo booth kit includes a cover 400 that is formed to cover the frame. The cover 400 is any suitable material that, together with the frame, form a photo booth. For example, the cover 400 is formed of large rectangular plastic or cloth sheet and can be wrapped around the frame. Hook and loop fasteners (e.g., Velcro®) or any other fixture technique can be used to fasten the sheet around the frame to form the finished photo booth. Notably, at least one panel (section) 402 in the cover 400 includes a chroma keyed color (e.g., green colored panel or green screen). Although depicted on the exterior, it should be noted that the panel 402 on the interior includes the chroma keyed color.

The sheet or cover can include a door cutout 404 or passageway that allows participants to enter the photo booth. As noted above, at least one interior panel 402 of the photo booth is a color that is chromo keyed to work with a particular chroma key app. For example, at least one interior panel of the booth is a “green screen” or “blue screen.” It should be noted that the specific dimensions illustrated are provided as one example of suitable dimensions; however, it should be understood that the invention is not intended to be limited thereto.

To further enhance the kit and as shown in FIG. 5, the kit can be formed to include props 500. The props 500 are any suitable props that can be worn or used by the participants in taking the photos or videos, non-limiting examples of which include hats, clothing, weapons, etc. As a non-limiting example, the props are relevant to the background scenes as stored in the tablet computer and rendered via the photo booth software application. For example, if the event is a movie themed event, then the background and props can all be coordinated with the movie theme. Further, printed photo paper and party supplies 502 (e.g., plates, cups, utensils, napkins, table cover, party bags, party favors, etc.) can also be provided with the kit. Both the photo paper and party supplies 502 can also be coordinated with the theme. Thus, the present invention is a photo booth kit that allows an event coordinator to quickly and effectively prepare and provide a photo booth to event participants. Importantly, the photo booth kit is adapted to hold a tablet or other device, with the tablet or other device having chroma key software to allow a user to take photos and/or videos and generate chroma key effects.

What is claimed is:

1. A system for superimposing images captured in a photo booth onto a selected background, the system comprising:
one or more processors and a memory, the memory being a non-transitory computer-readable medium having executable instructions encoded thereon, such that upon execution of the instructions, the one or more processors perform an operation of:
causing a tablet computer to obtain an image of a participant in from of a chroma-key panel and superimpose the image over a background that is stored in the tablet computer.

2. The system as set forth in claim 1, further comprising:
a photo booth kit, the photo booth kit including;
a frame, the frame having a tablet mount adapted to hold a tablet computer:
a cover, the cover formed to cover the frame and, together with the frame, form a photo booth, wherein at least one panel in the cover includes a chroma keyed color; and
a photo booth software application, the photo booth software application being operable to cause the tablet computer to obtain an image of a participant in front of the panel and superimpose the image over a background that is stored in the tablet computer and rendered by the photo booth software application.

3. A computer program product for superimposing images captured in a photo booth onto a selected background, the computer program product comprising:
a non-transitory computer-readable medium having executable instructions encoded thereon, such that upon execution of the instructions by one or mote processors, the one or more processors perform an operation of:
causing a tablet computer to obtain an image of a participant in from of a chroma-key panel, and superimpose the image over a background that is stored in the tablet computer.

4. A computer implemented method for superimposing images captured in a photo booth onto a selected background, the method comprising an act of:
causing one or more processers to execute instructions encoded on a non-transitory computer-readable medium, such that upon execution, the one or more processors perform an operation of:
causing a tablet computer to obtain an image of a participant in from of a chroma-key panel and superimpose the image over a background that is stored in the tablet computer.
